(19) United States
(12) Patent Application Publication
(10) Pub. No.: US 2002/0001792 A1
(43) Pub. Date: Jan. 3, 2002

(54) Spanish pronunciation enhancement teaching method

(76) Inventor: Eleanor L. Chatman, Chicago, IL (US)

Correspondence Address: Greenberg and Lieberman Law Office, 314 Philadelpha Ave., Takoma Park, MD, 20912, US

(21) Appl. No.: 09/873,955

(22) Filed: Jun. 4, 2001

Related U.S. Application Data
(60) Provisional application No. 60/208,484, filed on Jun. 2, 2000.

(51) Int. Cl. G09B 19/04

(52) U.S. Cl. 434/185

(57) ABSTRACT

A language learning system for native English speakers learning Spanish, concentrating primarily on vowel sounds pronunciation, allowing the learner to overcome the obstacles of pronunciation of unknown words.

### REFERENCE TO EARLIER APPLICATION

Priority is hereby claimed to Provisional Patent Application No. 60/208484 filed on Jun. 2, 2000 in the name of Eleanor L. Chatman for a Spanish Pronunciation Enhancement Teaching Method.

### FIELD OF THE INVENTION

The present invention relates generally to the art of teaching foreign languages. More particularly, the present invention offers a fundamental teaching method enabling instructors to more effectively assist their English-speaking students to properly pronounce Spanish.

### BACKGROUND OF THE INVENTION

It is commonly known that the best way to learn a new language, regardless of age, is through complete immersion in an environment whose inhabitants primarily speak the language of intended acquisition. It is also commonly recognized that it is nearly impossible to simulate such an environment, short of living in the native country. There are, of course, fast track language programs designed to give its pupils an intensive overview of the most functional and necessary language components required in order to obtain a working knowledge of a particular language. There is also a proliferation of “traditional” language classes that gradually expose students to increasingly sophisticated levels of grammar, syntax, vocabulary, reading and speaking skills from year to year. Supplemental, but rarely attended, conversational classes are frequently offered to provide a means to focus on verbal language skills. Each of the types of aforementioned classes generally subscribes to a suitable curriculum intended to accomplish their respective objectives. These same curriculums are generally accompanied by various texts or manuals from which the instructor is expected to draw education materials and ideas. One of the least developed areas in the majority of language skills programs is an effective means of teaching pronunciation. It is generally understood that such auditory speaking skills will increase proportionately with the frequency of conversations held in that tongue. Unfortunately, abilities to “parrot” intonation, inflections, punctuation, accents and pronunciation are unique and individual. Some language students may find that they have an instant or inherent sensitivity for proper enunciation, while most will find that despite a high level of comprehension, they are unable to perfect the sound of the language.

Prior relevant art are teaching methods and manipulatives which often either lack the means for or gloss over the importance of incorporating pronunciation tools throughout the language learning process, which is the novel concept underlying the present invention.

U.S. Pat. No. 1,271,856, issued to Cook, on Jul. 9, 1918, is a language card game which includes phrases, pronunciation key and imagery all intended to aid in the acquisition and retention of basic conversational phrases within a short time of playing the game. Although pronunciation pointers are interspersed on individual cards, there is no intentional systematization or technique through which a student of the game can comprehensively acquire and refine a formula for pronouncing the language at large.

U.S. Pat. No. 3,670,427, issued to Stolpen on Jun. 20, 1972, is an apparatus for teaching language systems using alphabet blocks which can be assembled into morphemes, graphemes and phonemes of which the language is composed. Although this art is a nicely packaged device for tutoring individuals, it again is not a holistic means for incorporating oral skills into the language learning process.

U.S. Pat. No. 4,067,122, issued to Fernandez on Jan. 10, 1978, is a language game intended for use by players “A” and “B” for example, who then conduct a conversational question and answer dialogue as prompted by the complimentary lesson planners used by player “A” and player “B” (note: the lesson planners are not the same and must be used in tandem with each other). This art focuses on a quick introduction to the language, but does not hone any particular skill or present a holistic means for mastery of the fundamentals of the language, including pronunciation.

U.S. Pat. No. 4,609,357, issued to Clegg on Sep. 2, 1986, offers a means for word for word phonetic language translation through a series of tables breaking the components of a word into its smallest elements or phonemes. Although this technique provides visual indicia for how certain letter and word constructions should sound, it is not part of a sequence or series of steps needed to insure a holistic comprehension of the language fundamentals including pronunciation.

International Patent No. WO 87/06752, issued to Lloyd on Nov. 5, 1987, is a text and audio-speaking device with a light wand capable of reading bar coding correlating to particular words and sentences in the text and then verbalizing them out loud. This device is intended to simulate the one on one presence of a tutor assisting in obtaining reading and speaking skills. Although this device provides visual text and audio indicia for how certain words sound, it is not part of a sequence or series of steps needed to insure a holistic comprehension of the language fundamentals including pronunciation.

U.S. Pat. No. 5,429,513, issued to Diaz-Plaja on Jul. 4, 1995, is an interactive teaching device using music and graphics as memory aids to instruct in the elementals of a language. This individually activated sound generating apparatus is intended for use as part of an integrated language program.

The present invention offers a direct, formulaic means of familiarizing English speaking Spanish language students with the fundamentals, along with a particular emphasis on the pronunciation of Spanish vowels, in order to reconfigure contradictory oral predilections, effectively remove some of the sound barriers inherent in non-native speakers and thus enabling the students to become more comfortable with the language by helping to diffuse preconceptions and typical learning blocks, as the students gradually become more able to closely reproduce the sound and structure of the Spanish vernacular.

### SUMMARY OF THE INVENTION

The present invention is an oral language skills teaching method which is intended to increase the abilities of Spanish language students to pronounce and enunciate Spanish properly through a structured series of oral exercises featuring repetitions of various configurations of Spanish vowels and consonants which help to reconfigure or expand such vocal tendencies commonly ascribed to students who speak English as their primary language.

### BRIEF DESCRIPTION OF THE TEACHING METHOD

Step One delineates the basic rules about Spanish pronunciation through emphasis on its vowels.

Step Two relates to the introduction of the Spanish alphabet and phonetic system.

Step Three relates to the introduction of the “definite articles” in Spanish.

Step Four relates to the introduction of Spanish vocabulary with the appropriate “definite articles”.

Step Five suggests the introduction of a mid-way barometer of pronunciation skills.

Step Six relates to the clarification of fundamental distinctions between Spanish and the native language (English) of the students.

Step Seven relates to the introduction of basic verbs.

Step Eight relates to the introduction of the plural forms of the “definite articles”.

Step Nine relates to an emphasis on pronunciation of “key” sounds through the use of dipthongs.

### DETAILED DESCRIPTION OF THE PREFERRED EMBODIMENT(S)

### STEP ONE

### Pronunciation Rules

The sounds of Spanish vowels are:

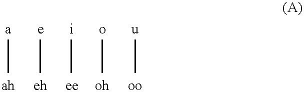

Every letter of any Spanish word must be pronounced. The sounds of the vowels never change. For example, if “a” makes the sound of “ah” in one part of a word, it makes that same sound in any other part of the same word.

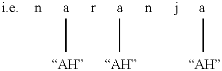

Additionally, every letter of this word must be enunciated for proper pronunciation (“enunciation rule”).

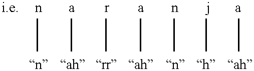

There are only few exceptions to the enunciation rule.

i. The letter “h” in Spanish is always silent, unpronounced (mute).

ii. The letter “q” always sounds like “k” when followed by a “u”.

iii. In isolated cases, the letter “g” is pronounced like “g” when followed by

the letter “u”. (“u” is silent when preceded by a “q” or “g”).

### STEP TWO

### Alphabet and Phonetics

Once the basic pronunciation rules have been reviewed and understood by the students, the Spanish alphabet is introduced and memorized. Then each individual consonant should be studied and pronounced separately. Finally, each consonant is pronounced in conjunction with each of the five vowels.

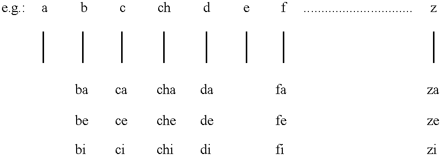

### STEP THREE

### Definite Articles

Distinguish between the four (4) in Spanish and the one (1) in English.

### STEP FOUR

### Vocabulary

Teach relevant vocabulary (as much or as little as the applicable curriculum suggests). Vocabulary words should be spelled out, written and spoken for accuracy and comprehension; examinations to reinforce retention of such vocabulary words are advised.

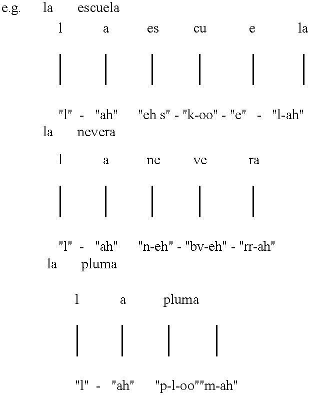

### STEP FIVE

### Parangaratutirimicuaro

Pronunciation of one of the most difficult words in the language may be taught as a break in the drudgery of rote.

### STEP SIX

### Fundamental distinctions between Spanish and English

Such distinctions include:

1. Gender and quantity characterize Spanish nouns, whereas English words are only characterized by quantity. (i.e. Spanish nouns indicate whether masculine and feminine, plural and singular; English nouns indicate only whether plural or singular.)

2. Spanish has four (4) different terms of expression or articles meaning “the” in English and two different expressions meaning the third person “one” in English.

3. Spanish articles must always agree, in both number and gender, with the noun (person, place or thing) it modifies; English articles do not.

### STEP SEVEN

### Verbs and Prepositions

Begin with the verb “to be”. There are two Spanish terms for the singular “is” and two Spanish terms for the plural “are”. Spanish words for the basic prepositions such as “on”, “in”, “inside”, “behind”, “under”, “above”, etc. . . . should also be taught at this juncture. The most commonly used singular and plural forms for “to be” “esta” and “están” should be spoken in association with vocabulary words learned in STEP SIX and the prepositions learned in this STEP SEVEN.

e.g. El lápiz está detras de la mesa.

### STEP EIGHT

### Plural forms of Articles and Vocabulary

Re-introduce and repeat the plural forms of the definite articles and vocabulary learned in previous steps in association with the word “are” in Spanish or “están” in like manner to

### STEP SEVEN with singular nouns, using article, gender and verb agreement.

e.g. Las mesas están en el comeda.

Los cuardros están en la pared.

Los lápices están encima de la mesa.

### STEP NINE

### Dipthongs

This step is integral to a student□s complete assimilation with the sounds of the Spanish language and will further the ability to naturally flow into Spanish pronunciation once learned by rote, both orally and in written form.

| | | | | |
|---|---|---|---|---|
| aa | ea | ia | oa | ua |
| ae | ee | ie | oe | ue |
| ai | ei | ii | oi | ui |
| ao | eo | io | oo | uo |
| au | eu | iu | ou | uu |

If the elements of all of the preceding STEPS are concertedly integrated into any core language teaching program, students overall abilities to properly enunciate and pronounce Spanish words, sentences and phrases will be increased dramatically.

I claim:

1. A method of learning the Spanish language for English speakers, comprising:
a vowel pronunciation guide,
a consonant pronunciation guide, used in conjunction with said vowel pronunciation guide,
a vocabulary list for the English speakers, used in conjunction with said vowel pronunciation guide, and said consonant pronunciation guide,
a list of rules to indicate the major differences between Spanish grammar and English grammar,
a guided instruction of longer or harder to pronounce words in the Spanish language, to provide a break for the English speakers,
a system of learning of verbs and prepositions in the Spanish language used in conjunction with said vocabulary list,
a system of learning plural forms of nouns and articles associated with nouns used in conjunction with said vocabulary list; and
a pronunciation lesson in dipthongs, or vowel combinations used in conjunction with said vowel pronunciation guide.

2. A method of learning the Spanish language for English speakers as in claim 1, wherein said vowel pronunciation guide is presented with phonetic pronunciations for each vowel.

3. A method of learning the Spanish language for English speakers as in claim 1, wherein said consonant pronunciation guide is presented with phonetic pronunciations for each consonant.

4. A consonant pronunciation guide as in claim 3, wherein each consonant is paired with each vowel, allowing the English speaker to pronounce each consonant in the alphabet in conjunction with each vowel in the alphabet.

5. A method of learning the Spanish language for English speakers as in claim 1, wherein said vocabulary list is congruous with the level of language instruction that the English speaker has received in Spanish.

6. A method of learning the Spanish language for English speakers as in claim 1, wherein said system of learning of verbs and prepositions, further comprises instruction in the different prepositions and nouns from said vocabulary list in conjunction with said verbs.

7. A system of learning verbs and prepositions as in claim 6, wherein the first verb that the English speakers learn is the Spanish translation of “to be”.

8. A method of learning the Spanish language for English speakers as in claim 1, wherein said system of learning plural forms of nouns and articles associated with nouns displays the innate differences between English articles and plurals, with Spanish articles and plurals, which have dissimilar language rules.

9. A method of learning the Spanish language for English speakers as in claim 1, wherein said dipthong pronunciation guide is presented individually, and as part of words that encompass dipthongs.
